(19) United States
(12) Patent Application Publication
(10) Pub. No.: US 2010/0005178 A1
(43) Pub. Date: Jan. 7, 2010

(54) METHOD AND SYSTEM FOR FIREWALL FRIENDLY REAL-TIME COMMUNICATION

(76) Inventors: Catalin Sindelaru, Bucharest (RO); Franco Tocan, Vaslui (RO); Kent Michael Nørregaard Rasmussen, Slagelse (DK)

Correspondence Address: OSTROLENK FABER GERB & SOFFEN, 1180 AVENUE OF THE AMERICAS, NEW YORK, NY, 100368403, US

(21) Appl. No.: 12/447,106

(22) PCT Filed: Oct. 24, 2006
(86) PCT No.: PCT/DK06/50065

§ 371 Date: Sep. 4, 2009

(51) Int. Cl. G06F 15/16

(52) U.S. Cl. 709/228; 709/234; 709/240

(57) ABSTRACT

Method and system for transmitting packets of different data types from a sender client to a receiver client over a server client connection established in a packet switched network, where a transport protocol connection for each data type to be transmitted is established between the sender client and the receiver client using the server client, the data transfer rate of one or more data type connections are measured at the server client, which transfer rate is sent as feedback information to the sender client, the sending rate at the sender client is adapted based on the feedback information from the server client and the transfer rate measured by the sender client, data types are prioritized in priority and non-priority delay sensitive data types by marking the data packets, non-priority data type packets are dropped at the sender client if the transport connections dedicated for non-priority data are too busy to send more data, the individual data types are separately buffered at the server, non-priority data type packets are dropped at the server before they are buffered if a corresponding dedicated data type buffer with a size of N packets is full until the buffer contains a number of M packets, where M<N.

The present invention relates to transmission of information across networks, more specifically to methods and systems for fast real-time transmission of information across the Internet and within networks or networked systems.

Network based applications like conferencing or collaboration systems, which share local data and applications and provide real-time audio and video communication, require real-time transmission and exchange of data for effective implementation and use of those features. There exist several protocol suites that provides fast, real time data exchange to present video and audio data between users in local and remote locations. Typically, real-time data is transmitted over the unreliable User Datagram Protocol UDP (UDP/IP). The advantage of using the unreliable UDP protocol instead of the reliable Transmission Control Protocol TCP (TCP/IP) is primarily an increased speed of packet delivery for the real-time applications that does not require reliable data transmission. This is possible because UDP has less overhead and does not transmit packet acknowledgement, packet verification, packet re-transmission requests, etc. In real-time media transmission, such transmissions and verification processes negatively impact the system performance regarding fast packet delivery.

The TCP protocol is the dominant transport layer protocol for network communication and the TCP protocol provides the highest degree of reliability by ensuring that all data is received and that it is received in the correct order, as well as the received data is accurate and consistent with the data that was transmitted. In many applications, such a reliability is crucial for effective and useful data transmission.

It would be desirable if real-time data could be carried over TCP connections because TCP connections are widely accepted by most fire-walls, since this type of connection is used for other purposes such as web browsing. TCP transmission ports are known to be friendlier to network security than UDP ports, which in general are seen as security threat. In businesses such as bank and finance, security is of highest priority, and communications via UDP ports must be avoided.

However, it is well recognized that the TCP protocol is not of practical use for communication of real-time transmission such as voice and video data. This is due to the fact that TCP connections will often introduce significant delays and throughput variations in the delivery of data, because of the changes in the network load and the reliable nature of the protocol. The design goal of TCP has been to provide a reliable network connection as opposed to real-time and constant-flow network connections using the UDP protocol. Accordingly, the throughput of a typical TCP connection varies according to the network packet-delivering situation.

The dilemma is that if UDP is used to provide real-time communication, the UDP connections are very likely to be blocked by firewalls. However, if TCP is used, the result is stuttering of the data, which is unacceptable for video and in particular for audio communication. The stuttering occur in case of a data packet loss, where the TCP receiver will wait and hold all the following packets until the lost packet is resent and received. When the lost packet is resent and arrives, all the held packets are delivered to the application at once. This causes the well-known stall-and-fast-forward symptom when using TCP as transport protocol. Most operating systems are implementing the TCP protocol with individual send and receive buffer sizes for each connection, which is also called socket buffer sizes. These buffers implies that applications sending data to a TCP connection will experience the data as sent when is reaches the send buffer, which will cause problems for real-time transmission, since packets with useful data are delayed.

US Patent Application 2006/0198300 (Li et al.) describes a method for using the TCP-protocol for real-time communication such as video and audio transmission. The method disclosed in said application teaches that the problems using TCP for real-time communication can be solved by opening a plurality of TCP connections and by choosing the least congested connection for the transmission of each packet of data. The selection of connection is done by monitoring the plurality of TCP connections and by determining the queue of data to be sent over each individual connection.

This method does not adapt the transmission rate of packets to the available capacity of the network, and thus assumes that at least one of the connections is ready to transport data. Hence it does not solve the problems that caused the congestion, and does not teach how several connections of different data types are transmitted simultaneously.

US Patent Application 2002/0085587 discloses a method for end-to-end bandwidth estimation between a server and a client in a packet network such as IP, which method is used to regulate the data rate at the client side to improve the throughput of the transport protocol. The method can be used with any transport protocol and solves the problem of lacking fairness to TCP connections when they compete with UDP connections on a communication link. The method estimates the available bandwidth by measuring the received amount of data between two acknowledgements, which is somewhat similar to standard proposal RFC3448. The application describes the method to be used in connection with a transport protocol, but the application does not teach or point towards the use of the method in connection with the TCP protocol, since the fairness problem lies at the UDP protocol or similar protocols, which does not have congestion control mechanisms.

The congestion problem is described in the standard proposal TCP Friendly Rate Control (TRFC) described in RFC3448, which discloses an algorithm to make a reasonably fair allocation of bandwidth between TCP and UDP connections, which exists on the same link. The standard proposal describes the principle of measuring available bandwidth at the receiver side and sending feedback information from the receiver to the sender. TRFC is intended to be used in conjunction with a transport protocol such as UDP to improve fairness to TCP connections, but again nothing indicates that the principles should be used with TCP. The general considerations on congestion problems described in the standard proposal, gives the impression that use of large data packets could lead to a higher throughput for TCP as transport protocol.

The standard proposal RFC3714 discusses QoS and congestion regarding VoIP over the Internet in several aspects and teaches that network limitations in general lie in the transfer rate in bits per second Bps rather than the transfer rate in packets per second pps. But the standard proposal also states the same issue as mentioned above that the mechanisms found in TCP provide an incentive to use large data packets to obtain a larger throughput.

On the background outlined above it is the general object of the invention to provide a method and a system for real-time communication across networks using a firewall friendly protocol, where the short-comings and disadvantages described above are overcome.

To achieve these and other objects, as will become apparent from the following description, there is provided, according to a first aspect of the invention a method for transmitting packets of different data types from a sender client to a receiver client over a server client connection established in a packet switched network, where
a transport protocol connection for each data type to be transmitted is established between the sender client and the receiver client using the server client,
the data transfer rate of one or more data type connections are measured at the server client, which transfer rate is sent as feedback information to the sender client,
the sending rate at the sender client is adapted based on the feedback information from the server client and the transfer rate measured by the sender client,
data types are prioritized in priority and non-priority delay sensitive data types by marking the data packets,
non-priority data type packets are dropped at the sender client if the transport connection dedicated for non-priority data is too busy to send more data,
the individual data types are separately buffered at the server,
non-priority data type packets are dropped at the server before they are buffered if a dedicated data type buffer with a size of N packets is full until the buffer contains a number of M packets, where M<N.

By using this method the inventors has realized that the disadvantages that occurs when some transport protocols are used for real-time transmission can be reduced significantly, since the method minimizes the delay and congestion induced by packets that are buffered and retransmitted. This is achieved because the data transfer rates are measured at the sender client and the receiver client, and more important the server client sends the measured transfer rate as feedback information to the sender client. By using this feedback information to adjust the transfer rate at the sender client, congestion is reduced because the sending transfer rates are adapted to the available capacity. Because the data types are prioritized, packets that are susceptible to delays can be dropped or allocated more bandwidth and priority data type packets can be buffered in case the network connections are too busy to send more data or suffers from congestion. Data that cannot be sent right away, and which will suffer under delays will be dropped and therefore categorized as non-priority data, since the delivery of all packets are not crucial. This is due to the fact that for some data types packets are better of being dropped rather than delivered with a large delay.

To avoid oscillation of the buffer size at the server client in case of congestion and a delay of several packets and to achieve a smoother packet delivery, the server client will drop non-priority packets until the buffer or buffers dedicated for non-priority data type reaches a limit M, if the buffer reaches a upper limit N. This has shown to be especially effective when a non-priority buffer has a size N of 4 packets and a limit M of 2 packets.

In another embodiment of the invention the non-priority data type packets are dropped at the receiver client if a predetermined buffer with a size of P packets is full.

The process of dropping packets at the receiver does not give any feedback to the sender and will not influence the transfer rate of the sender. When network congestion happens, packets are sent with significant delays compared to the normal interval between e.g. two audio samples and by having a buffer of a limited size and dropping packets when it is full, delays will not be propagated if several packets are received at once after a period with congestion. By dropping non-priority packets at the receiver delays affecting the use of the received useful data is reduced.

In an embodiment of the invention the buffer P at the receiver has a size of 3 packets, which has shown to be especially efficient for preventing delays in real-time data transmission.

In a further embodiment of the invention connection send buffers at the sender client and at the server client are decreased in size or preferably disabled. This minimizes further delays because the notification of a sent packet is then received when the packet is actually sent on the connection and not as usually, when the packet is received in the connection send buffer. Hereby the management of buffers with data to send is handled at the client application level, which gives the client application more precise information about when the data packets actually are sent.

In an embodiment of the invention the method has shown to be especially useful regarding audio data and video data that will suffer from delays, as non-priority data with respect to the delivery of all data packets.

In another embodiment of the invention the transfer rate for each connection at the server client is calculated by measuring the number of received packets in T successive time intervals of duration D and where packets dropped by the server is not taken into account when the transfer rate is calculated. This approach is very simple to implement and provides useful information for adapting the transfer rate at the sender client. By not taking dropped packets into account, this will cause the sender client to lower its sending data rate, and thereby limiting the possibility for congestion and latency on the connections.

In another embodiment of the invention the transfer rate of non-priority data type connections are adapted at the sender client by limiting the transfer rate of another non-priority data type connection or a priority data type connection. This makes sure that data, which is regarded as non-priority with respects to delivery of all packets, are favoured in terms of bandwidth in order to reduce packet delay and congestion.

In another embodiment of invention the data type transfer rates at the sender client is adapted by changing the video or audio sampling rate. This especially be useful when dealing with low capacity connections to make sure that the connections are not congested and that delay sensitive packets are buffered, but useful data still can be transmitted.

In another embodiment of the invention the same result is achieved by adapting the transfer rate of the data connections at the connection level by blocking the connections for specified time intervals.

In another embodiment the transmitted packet sizes correspond to the network MTU (maximum transmission unit). This reduces the impact of dropping non-priority packets, when a buffer is full or a connection is too busy to send more data. Normally when running other bandwidth consuming streams such as video and shared applications on the same link as e.g. audio data, the bandwidth consuming streams will normally send larger packets and get a higher transfer priority compared to the small packets of a audio stream that will be delayed. To prevent this to happen small packet sizes, which corresponds to the network MTU are used for all connections. This has shown to improve the both the overall transfer rate and the number of lost and dropped packets. This stems from the fact that if packets are larger than the network MTU, they are fragmented during transmission and all fragments of a packet must arrive at high-level protocol to get the packet. Therefore if any fragment of a packet is dropped, the entire packet must be retransmitted. The effekt of sending small packets is that the packets are not delayed due to fragmenting and retransmission of lost fragments.

In another embodiment of the invention the transport protocol is the transmission control protocol TCP, which makes it possible to communicate using existing firewall ports. This makes a system implementing the method of transmission described in the invention more secure than existing alternatives and makes real-time data transmission in environments where a high security level is required, possible.

In order to achieve the advantages of sending small packets the Nagle algorithm in the TCP protocol is disabled. This makes sure that a high transfer rate of small packets is favoured.

For the implementation of the transmission method and the advantages thereof described above there is provided, according to a further aspect of the invention, a system for transmitting packets of different data types from a sender client to a receiver client over a server client connection established in a packet switched network, where
a transport protocol connection for each data type to be transmitted is established between the sender client and the receiver client using the server client,
the data transfer rate of one or more data type connections are measured at the server client, which transfer rate is sent as feedback information to the sender client,
the sending rate at the sender client is adapted based on the feedback information from the server client and the transfer rate measured by the sender client,
data types are prioritized in priority and non-priority delay sensitive data types by marking the data packets,
non-priority data type packets are dropped at the sender client if the transport connections dedicated for non-priority data are too busy to send more data,
the individual data types are separately buffered at the server,
non-priority data type packets are dropped at the server before they are buffered if a corresponding dedicated data type buffer with a size of N packets is full until the buffer contains a number of M packets, where M<N.

In another embodiment of this aspect of the invention the non-priority data type packets are dropped at the receiver client if a predetermined buffer with a size of P packets is full.

In another embodiment of the invention connection send buffers at the sender client and at the server client are decreased in size or preferably disabled.

In another embodiment of the invention the non-priority data comprises audio data and/or video data.

In another embodiment of the invention the transfer rate at the server client is calculated by measuring the number of received packets in T successive time intervals of duration D and where packets dropped by the server is not taken into account when the transfer rate is calculated.

In another embodiment of the invention the transfer rate of non-priority data type connections are adapted at the sender client by limiting the transfer rate of another non-priority data type connection or a priority data type connection.

In another embodiment of the invention the data type transfer rates at the sender client are adapted by changing the video or audio sampling rate.

In another embodiment of the invention the transfer rate of the data connections is adapted at the connection level by blocking the connection for specified time intervals.

In another embodiment of the invention the buffer P has a size of 3 packets.

In another embodiment of the invention the buffer size for non-priority data at the server client is N=4 with M=2.

In another embodiment of the invention the transmitted packet sizes corresponds to the network MTU.

In another embodiment of the invention the transport protocol is the transmission control protocol TCP.

In another embodiment of the invention the Nagle algorithm is disabled.

In the following the invention will be further explained by way of a preferred embodiment as illustrated in the drawings, on which

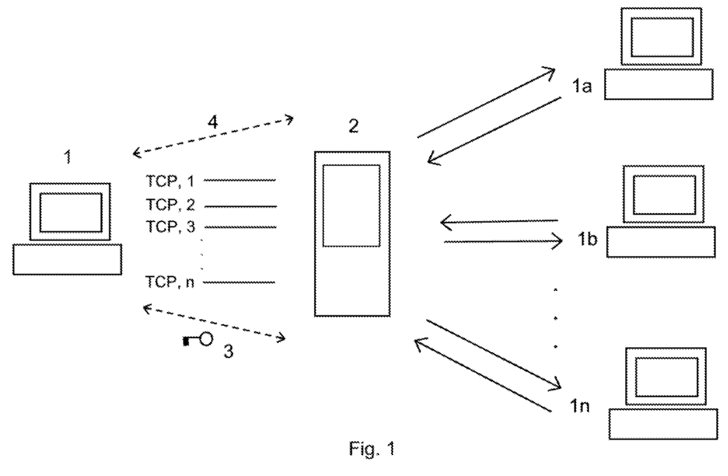

FIG. 1 illustrates a system implementing the method of the invention,

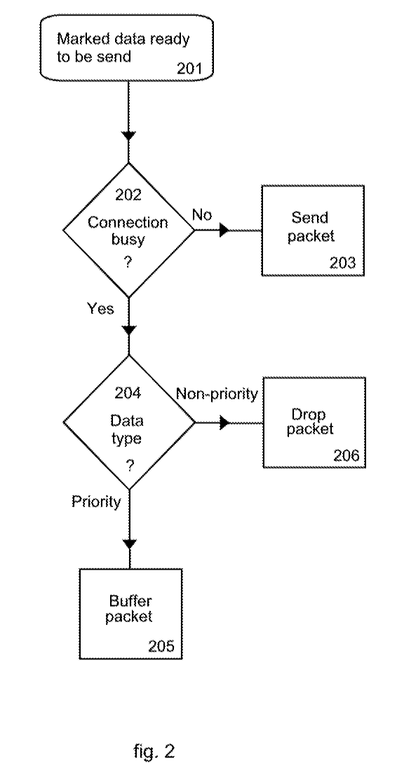

FIG. 2 is a block diagram of the handling of packets at a sender client,

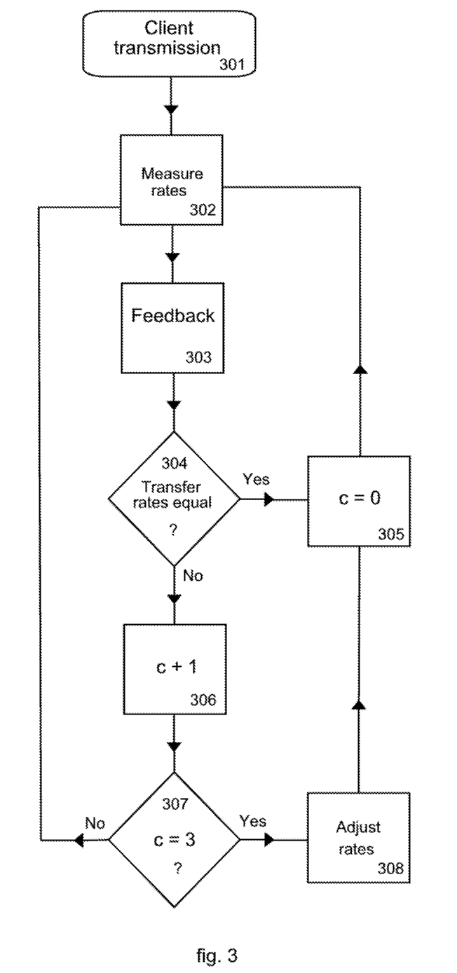

FIG. 3 is a block diagram showing how the transfer rate is measured and adapted at a sender client,

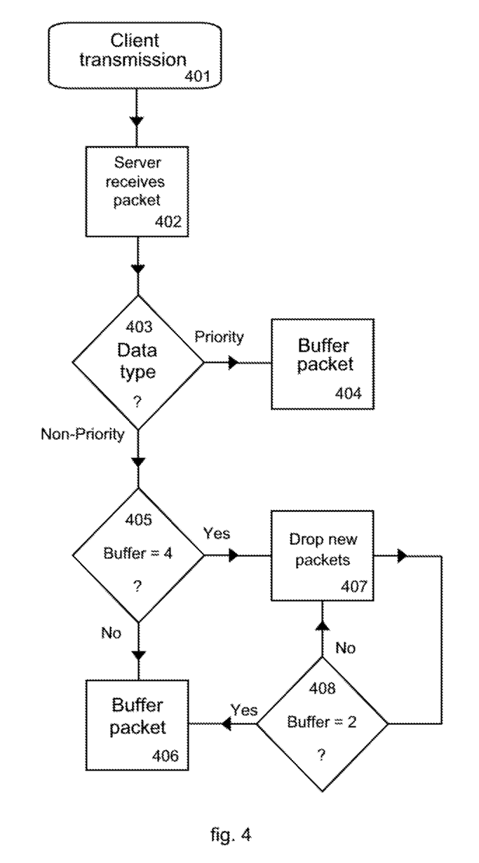

FIG. 4 is a block diagram showing how packets are buffered and dropped at a server,

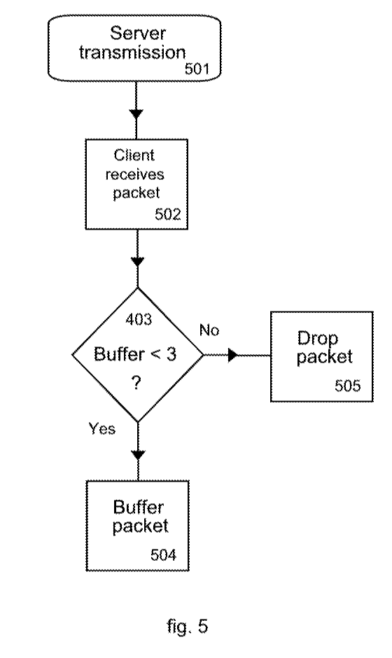

FIG. 5 is a block diagram showing how packets are buffered and dropped at a receiver client.

FIG. 1 shows a preferred embodiment where the method according to the invention is implemented in a system that provides individual connections for secure conference communication of data types comprising audio, video, application sharing and generic file transfer data, which connections all are created by default when the conference is created. For each individual data type connection there are two connections, one for sending and one for receiving. The connections are feature specialized and are dedicated for each their communication features as mentioned above. In general the individual data types comprise useful data. The system is based on a client-server model where a client application at the client computer 1 connects to a server application at a server 2 in order to perform real-time communication with one or more other clients 1a, 1b . . . 1n in the system. It is obvious to a person skilled in the art that one of the clients could act as a server (server client) to the other clients and that both clients and servers can act as both sender and receiver of data. The communication is based on firewall friendly real-time HTTPS-based streaming, which is carried by TCP/IP connections, and the security is ensured by exchange of public keys for encryption 3, hence the clients 1, 1a, 1b . . . 1n do not communicate directly with each other but through the server 2. The server 2 sends transfer rate feedback information 4 to the clients 1, 1a, 1b . . . 1n, which is used to adapt the transfer rates of the individual connections. The connections use port 80 or 443 and for other administrative purposes port 6085 is used.

The clients 1, 1a, 1b . . . 1n are equipped with audio and video capture equipment for the purpose of video and audio conferencing. A conference is established when a client e.g. client 1 requests the server 2 for the creation of a conference. In the same way a client 1, 1a, 1b . . . 1n can join a conference and thereby send and receive data from one or more of the other clients 1, 1a, 1b . . . 1n. During a conference, data that passes through the server needs to be decrypted and re-encrypted by the server since the client connections uses different SSL sessions.

During a conference, the captured audio samples are packaged in a connection specific format and sent through the server 2. At the receiver client the audio packets are extracted and played with an audio API corresponding to the one used for capturing the packets. In case of video, the capture frames are packaged and sent through the server, extracted at the receiver client and played with an video API corresponding to the one used for capturing the frames.

In the preferred embodiment the invention is used to implement a system that is more than just a conferencing system. The invention is preferably used to implement a collaboration system, where people at different locations can collaborate by sharing data, computer applications and their personal computer desktops, while having a conference session that provides real-time video and audio streaming between the users.

For sharing applications a mirror video driver is used to capture all screen changes and mouse and keyboard events. The updated screen regions are received as bitmaps and then archived using LZ compression. The archived content is packed in a connection specific format, as well as the mouse and keyboard inputs, and sent through the server. At the receiver client the images are unpacked and rendered in the application share window, together with mouse movements. In case of remote control, mouse movements and keyboard events are captured at the receiver end, sent through the server and transformed in the user input at the application share sender end.

During a file transfer, data is extracted from a disk file, packaged and sent through the server. The connection expects acknowledgement messages after each chunk of data and if no acknowledgements are received after a number of chunks, the sending is paused. At the receiver end the chunks are saved into a disk file.

During a conference data will be sent in both directions, which is handled by having connections 6 in both directions, but for the sake of simplicity only one side of the communications process is described in the following.

FIG. 2 illustrates how data packets are handled at the sender client, where packets are marked as priority and non-priority data, with respect to the importance of packet delivery. Hence data types that do not suffer from one or more packets being dropped, but which will suffer from delayed packets are marked as non-priority data. In the preferred embodiment audio and video data is categorized as non-priority data. Packets are sent from the client until a send function implemented in the TCP connection, reports it is too busy to send more data. In that case a OK to send flag is set to FALSE on the individual connection and non-priority packets are dropped and priority data are buffered until the connection signals readiness to sending more packets and the flag is set to TRUE. This principle is shown in FIG. 2 where a marked data packet in step 201 is ready to be sent and the state of the connections is checked in step 202. If the connection is ready to send the client application continues in step 203 where the data packet is sent. If the result in step 202 is that the connection is too busy to send data the client application checks the data type of the packet in step 204. If the packet is marked as priority data the data packets are buffered in step 205, but if the packet is marked as non-priority data the data packet is dropped in step 206. If the connection cannot accept any more data for direct send, the client application will drop data packets until the connection signals ready to send. Depending on the data nature and the marking of the data packets, the client application can buffer a number of packets before it starts to drop packets in order to avoid data starvation the moment the connection is ready to send data. It is obvious that data types can be prioritized differently, depending on the data nature. Each specific data types can have different buffer sizes or no buffers at all depending on the nature of the data to be transferred and a number of packets can be buffered before the sender client starts to drop packets.

FIG. 3 illustrates how the transfer rate of the individual connections between a server and a client are adapted. In step 301 the client application sends data to the server on the individual connections and in step 302 the server measures the actual transfer rate to the receiver client. This transfer rate is fed back to the sender client in step 303, which in step 304 compares the transfer rate measured by the server and the transfer rate measured by the sender client itself. A counter c is increased in step 306 if there is a difference between the two transfer rates and reset in step 305 if the two transfer rates are equal. The counter c counts the number of consecutive times the server reports a transfer rate that differs from the transfer rate at the sender client. In step 307 the client application checks if c is equal to 3, the process continues in step 302. If the server in 3 consecutive reports a difference between the two transfer rates (c is equal to 3 in step 307), the transfer rate at the client is adapted in step 308 and c is set to 0 in step 305. It should be understood that this is performed on each of the individual connections and that the counter c could be set to another limit for adjusting the transfer rate depending on the network conditions. Since all connections transfer rates are measured, the information about the individual transfer rates can be used to adapt the transfer rate to the actual demand. The transfer rate of one or more of the individual data type connections can be limited in order to increase the transfer rate of another data type connection. This will ensure that non-priority data can be provided with enough bandwidth to minimize the number of dropped packets and the delay of delivered packets. Based on the measurements made by the server on the actual transfer rates and the overall priority of the different connections, the transfer rate is adapted at the sender client. If for example the application needs X₁ bytes/s for the audio transmission and the server reports an effective transfer rate of X₂ bytes/s to the receiver client, where X₂<X₁, the application will limit the video transfer rate X₃ to X₃−(X₁−X₂), if the server for 3 consecutive feedbacks to the client reports that X2 is smaller than X1. It is obvious to a person skilled in the art, that the transfer rates can be adapted in several different ways depending on the circumstances and demands for the connections and that the transfer rate can be measured in several ways at different places in the system. In case the server estimation within a range is the same as the client estimation of the transfer rate and all connections can transfer at their current transfer rate for at few consecutive intervals, the client increases the transfer rate. It is obvious that said range could be defined according to the data type connections and the demands for the conference. The transfer rate of the connections can be increased on basis of the data types and on the demands and the nature of the individual data types, one connection can be allocated bandwidth before the other connections are increased. Typically the increment of the transfer rate is a percentage of the current transfer rate rate, that can be defined form the network conditions or transmission requirements for a given conference. It is obvious to a person skilled in the art that transfer rates can be increased in many other ways.

The limitation of the transfer rates are either performed at the sampling level by for example changing the video frames per second or the audio sampling rate or by blocking the connections for specified time intervals in order to achieve the desired data rate. When the transfer rates are adapted the audio data has preference over other data types as it cannot go under a pre-defined transfer value of 2.5 kbit/s. This is also the case for application share but in terms of bandwidth its priority comes after audio. The transfer rate of other connections can drop to almost 0. The server measures the transfer rate in step 302 by measuring the total number of bytes B transferred to the receiver client during 3 time intervals T of duration D=3 seconds. After T intervals the maximum value for B is chosen and divided by D to obtain the transfer rate R in bytes/s. It is obvious to a person skilled in the art that the transfer rate can be measured for other time interval and by using other transfer parameters, but the approach above is chosen in this embodiment.

FIG. 4 illustrates how non-priority data packets are dropped at the server depending on the sizes of the buffers dedicated to the individual connections to avoid oscillation of the buffers. The server constructs a buffer for each data type connection, which can be user defined or at default size, depending on the network conditions. When the buffer is filled with N packets, all incoming non-priority packets are dropped and the server only stop dropping new packets when the number of buffered packets reaches a number of M data packets, where M<N. Packets that are dropped will not be taken into account when calculating the transfer rate, as described in FIG. 3. In this way the server dropping packets will cause the sender to lower its data transfer rate. In step 401 a data packet is transmitted form a client and then received at the server in step 402. In step 403 the server determines the data type of the packet and buffers the packet in step 404 if the packet is a priority packet and a new packet can be received in step 402. If the packet in step 403 is determined to be a non-priority data packet, the server checks the buffer size in step 405. If the buffer size does not equal 4 packets the data packet is buffered and a new packet can be received in step 402. If the buffer size is determined to be equal to 4 packets in step 405, the server will start to drop new data packets in step 407, until the buffer size is 2 packets as illustrated in step 408. In the embodiment illustrated above the limits for N and M is set to 4 and 2,but other limits can be used as well, but the values used in the example has shown to work with most network conditions. It is clear that under perfect conditions no buffers are needed because the server then can send the packets immediately and do not require a buffer. It is also obvious that the values can be user specified upon the set up of a connection if the server or the client are aware of certain network conditions that requires special buffer sizes or if a larger delay of non-priority packets can be accepted in a special case.

In the preferred embodiment of the invention the connection send buffers at the clients 1, 1a, 1b . . . 1n and the server 2 are disabled or if the specific implementation does not allow this, their sizes are reduced to a minimum. Hereby the notification of a sent packet is received when the packet is actually sent on the connection and not as usually, when the packet is received in the connection send buffer.

In the preferred embodiment the data packets are transmitted on the connections in packet sizes equal to and around the size of the network MTU. As shown in FIG. 1 the invention is preferably implemented with the TCP protocol and to ensure that small packets are not discriminated, the Nagle algorithm is disabled both at the server 2 and the clients 1, 1a, 1b . . . 1n. The data type packets need not to be fixed or equal in sizes and in a preferred implementation the data packets for audio will be around 110 to 450 bytes, for video up to 2.5 kB, for application share 100 to 1400 bytes, for file transfer 350 bytes to 2 kB and for a data connection usually under 1 kB. Typically the connections are carried over Ethernet, which typically has an MTU of 1500 bytes. Sending smaller packets increases the transmission rate in terms of sent packets per second, which requires more processing at the clients 1, 1a, 1b . . . 1n and the server 2. It is obvious to a person skilled in the art that the packets can also be chosen a other sizes e.g. inferior to the network MTU, but the above sizes has shown to be especially efficient.

In FIG. 5 is illustrated how non-priority packets are dropped at the receiver client in order to avoid delays in a audio or video play queue and to ensure that delays in the packet delivery are not propagated. In step 501 the server sends a packet to the receiver client, which is received in step 502 and in step 503, the receiver client checks the size of the buffer for non-priority data. If the number of packets in the buffer is less than 3 the data packet is buffered in step 504. If the buffer is equal to or larger than 3, the packet is dropped in step 505. The process of dropping packets at the receiver end does not give any feedback to the sender and will not influence the sender clients transfer rate. When TCP congestion happens, packets are sent with significant delays compared to the normal interval between e.g. audio samples of 40 ms. In this case more than one packet can be received at one after a long period of not receiving any packets. If all non-priority packets are buffered e.g. for playing at a normal rate, the delay form such events will propagate. This is avoided with a buffer as described at the receiver client and it is obvious that the buffers can have other sizes and that the buffer size can be adjusted with other principles, just like the buffer management described with respect to the server.

1-26. (canceled)

27. Method for transmitting packets of different data types from a sender client to a receiver client over a server client connection, where
a TCP connection for each data type to be transmitted is established between the sender client and the receiver client using a server,
the TCP connection send buffers at the sender client and the receiver client and at the server are decreased in size or disabled,
the Nagle algorithm is disabled,
a data transfer rate of one or more data type connections is measured at the server, which transfer rate is sent as feedback information to the sender client,
a sending rate at the sender client is adapted based on the feedback information from the server and the transfer rate measured by the sender client,
the data types are prioritized in priority data types and delay sensitive non-priority data types by marking the data packets,
non-priority data type packets are dropped at the sender client if the TCP connections dedicated for non-priority data are too busy to send more data, the data types are separately buffered at the server, non-priority data type packets are dropped at the server before they are buffered if a corresponding dedicated data type buffer with a size of N packets is full until the buffer contains a number of M packets, where M<N,
the non-priority data type packets are dropped at the receiver client if a predetermined buffer with a size of P packets is full.

28. Method according to claim 27, wherein the non-priority data types comprises audio data and/or video data.

29. Method according to claim 27, wherein the transfer rate at the server is calculated by measuring the number of received packets in T successive time intervals of duration D and where packets dropped by the server is not taken into account when the transfer rate is calculated.

30. Method according to claim 27, where the buffer P has a size of 3 packets.

31. Method according to claim 27, where the buffer size for non-priority data at the server client is N=4 with M=2.

32. Method according to claim 27, where the transfer rate of one non-priority data type connection is adapted at the sender client by limiting the transfer rate of another non-priority data type connection or a priority data type connection.

33. Method according to claim 27, where the data type transfer rates at the sender client are adapted by changing the video or audio sampling rate.

34. Method according to claim 27, where the transfer rate of the data connections is adapted at the connection level by blocking the connection for specified time intervals.

35. System for transmitting packets of different data types from a sender client to a receiver client over a server client connection, where
a TCP connection for each data type to be transmitted is established between the sender client and the receiver client using a server,
the TCP connection send buffers at the sender client and the receiver client and at the server are decreased in size or disabled,
the Nagle algorithm is disabled,
a data transfer rate of one or more data type connections is measured at the server, which transfer rate is sent as feedback information to the sender client,
a sending rate at the sender client is adapted based on the feedback information from the server and the transfer rate measured by the sender client,
the data types are prioritized in priority data types and delay sensitive non-priority data types by marking the data packets,
non-priority data type packets are dropped at the sender client if the TCP connections dedicated for non-priority data are too busy to send more data,
the data types are separately buffered at the server,
non-priority data type packets are dropped at the server before they are buffered if a corresponding dedicated data type buffer with a size of N packets is full until the buffer contains a number of M packets, where M<N,
the non-priority data type packets are dropped at the receiver client if a predetermined buffer with a size of P packets is full.

36. System according to claim 35, wherein the non-priority data types comprises audio data and/or video data.

37. System according to claim 35, wherein the transfer rate at the server is calculated by measuring the number of received packets in T successive time intervals of duration D and where packets dropped by the server is not taken into account when the transfer rate is calculated.

38. System according to claim 35, where the buffer P has a size of 3 packets.

39. System according to claim 35, where the buffer size for non-priority data at the server client is N=4 with M=2.

40. System according to claim 35, where the transfer rate of one non-priority data type connection is adapted at the sender client by limiting the transfer rate of another non-priority data type connection or a priority data type connection.

41. System according to claim 35, where the data type transfer rates at the sender client are adapted by changing the video or audio sampling rate.

42. System according to claim 35, where the transfer rate of the data connections is adapted at the connection level by blocking the connection for specified time intervals.
